(19) United States
(12) Patent Application Publication
(10) Pub. No.: US 2023/0418065 A1
(43) Pub. Date: Dec. 28, 2023

(54) AR Smart Glasses

(71) Applicant: QiLun Sun, Cocoa, FL (US)

(72) Inventor: QiLun Sun, Cocoa, FL (US)

(21) Appl. No.: 17/850,926

(22) Filed: Jun. 27, 2022

(51) Int. Cl. G02B 27/01; G02B 27/12

(52) U.S. Cl. CPC G02B 27/0172; G02B 27/126; G02B 27/123; G02B 2027/0178

(57) ABSTRACT

An optical system for smart glasses to combine digitally generated content with views from environment, comprising a transparent shell assembly and a digital image formation device. The transparent shell assembly comprising an inside layer, an outside layer, and a transparent thin film placed in between the inside layer and the outside layer. The transparent thin film allows light from real world scene to pass through and reach the eye of the wearer of the smart glasses. The transparent thin film is slanted in a way such that light from the display can be reflected by the transparent thin film to the eye of the wearer of the smart glasses.

### CROSS-REFERENCE TO RELATED APPLICATION

This application claims the benefit of the filing date of U.S. Provisional Patent Application No. 63/215,516, filed Jun. 27, 2021, the disclosures of which are hereby incorporated by reference herein.

### BACKGROUND OF INVENTION

### 1. Technical Field

The present invention relates to augmented reality smart glasses, or near-to-eye displays, with an optical system for generating a virtual image in the user's field of view.

### 2. Description of Related Art

There are numerous smart glasses products on the market, but due to the optical design and some other factors, current smart glasses are either bulky, or heavy, or otherwise cannot be shaped like a pair of regular glasses. These factors hindered the adoption by general consumers.

### OBJECTS AND ADVANTAGES

The object of this invention is to provide a solution for lightweight smart glasses, enabling smart glasses to look like a normal pair of glasses, with minimal number of components, highly transmissive, easy to carry, and easy to manufacture.

### BRIEF SUMMARY OF THE INVENTION

This invention discloses optical imaging solutions for generating a virtual image in the user's field of view, with a minimal number of components that are easy to manufacture.

### BRIEF DESCRIPTION OF DRAWINGS

FIG. 1A Depicts an optical combiner system for smart glasses.

FIG. 1B Depicts an optical combiner system for smart glasses as in FIG. 1A, in a different view angle.

FIG. 1C Depicts the structure of one embodiment of AR smart glasses display system that are based on the optical combiner system as in FIG. 1A.

FIG. 2 Depicts the placement of the components inside the glasses frame.

FIG. 3 Depicts the internal components and light path.

FIG. 4A Depicts an optical solution that use a prism with a 45-degree angle to extend the distance from display to optical lenses.

FIG. 4B Depicts an optical solution as in FIG. 4A, in perspective view.

FIG. 4C Depicts an optical solution that use a prism with a 30-degree angle to extend the distance from display to optical lenses.

FIG. 4D Depicts an optical solution as in FIG. 4C, in perspective view.

FIG. 4E Depicts an optical solution as in FIG. 4C, shown inside a sample smart glasses embodiment.

FIG. 5A Depict an optical solution that use a more complex prism to extend the distance from display to optical lenses.

FIG. 5B Depict an optical solution as in FIG. 5A, in perspective view.

### DETAILED DESCRIPTION

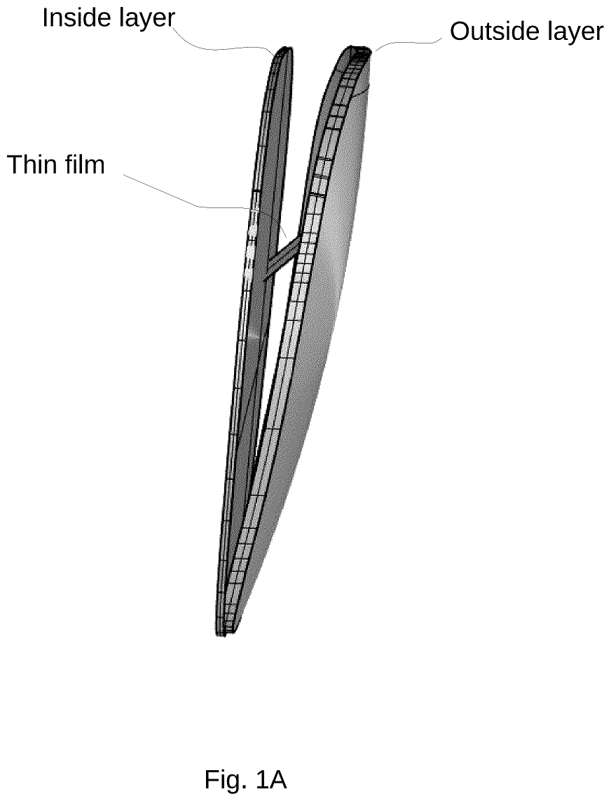

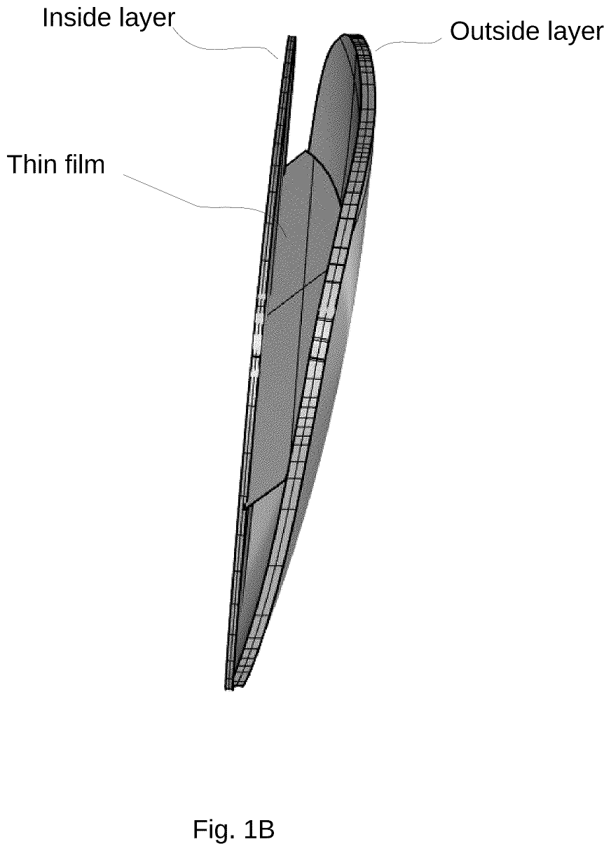

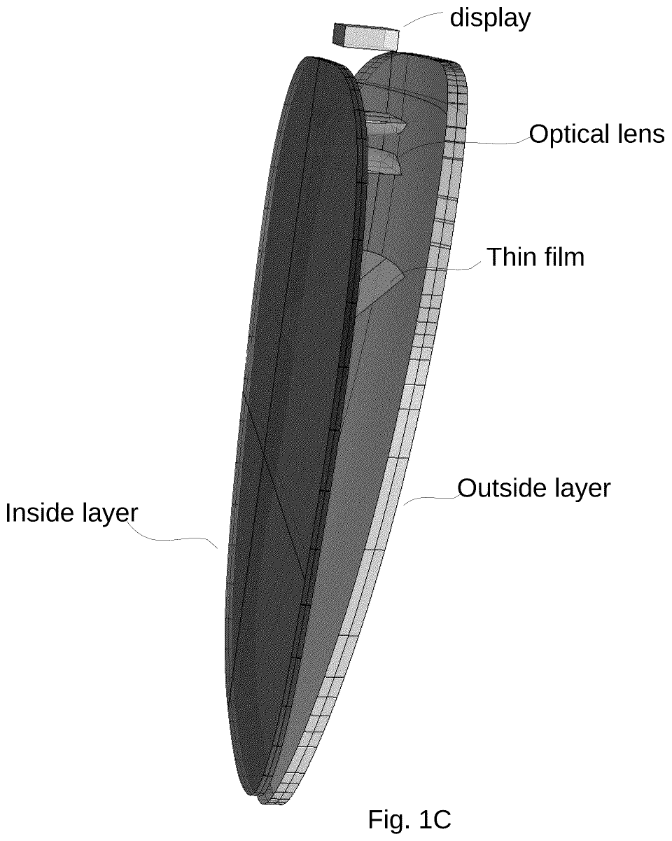

FIG. 1A depicts an optical combiner assembly which composed of 3 elements: a transparent inside (eye-ward side) layer, a transparent outside (external scene side) layer, and a transparent thin film which is sandwiched in between the inside and outside layers.

The outside layer maybe curved, take the shape of regular sunglasses lenses. The inside layer maybe flat or curved. Both layers may be attached to the glasses frame. When the outside layer is curved and the inside layer is flat, a chamber will be formed in the middle of the assembly, which can provide enough space for the transparent thin film; the bottom and sides of the assembly are narrow, can be fitted into a frame that resemble regular sunglasses. Its not necessary for either of the two layers to be attached to the glasses frame all around, and inside layer may not need to overlap completely with outside layer.

The term “thin film” used in this document refer to a thin plate structure that can serve as a half-mirror. It can be made of polycarbonate, glass, or other transparent materials. It is rigid enough to hold the planar shape without wobbling. It can be coated to increase the reflection rate, in this case, we can refer it as beam splitter plate. Or we can use a beam splitter cube, in this case, the transparent thin film can refer to the beam splitting surface inside a beam splitter prism.

The transparent thin film is placed slantly, in a way such that it can reflect light originated from an imaging source (which can be placed above or upside of the thin film) to eye. In a variant arrangement, the thin film is slanted in a way such that it can reflect light from an imaging source placed on the left side (or right side) of the thin film to eye. The imaging source can be a micro display using technologies such as OLED, Micro-LED, LCOS, LCD, DLP, etc., and the light originated from the imaging source may pass through some optical systems before reaching the transparent thin film.

Outside layer can be curved like in regular sunglasses or prescription glasses. It can be clear, or tinted to different color/shades, or use transition (photochromic) lenses. Either outside layer or inside layer can also be coated such that they could block blue light, or UV light. In addition, either outside layer or inside layer can be prescription lenses; it can use prescription lenses from regular eye care stores. Smart glasses constructed like in this embodiment can be cleaned/wiped in same way as for regular glasses.

Lights from real world scene pass through the outside layer, thin film, and the inside layer, then reach the eye. Since all three can be transparent, this structure yield to high transmissive rate for outside light, which is important for AR smart glasses in certain use cases.

Likewise, lights reflected from the face, eye etc. can pass through the inside layer, thin film, and the outside layer, reach eyes of surrounding people; thus, surrounding people can see the eyes of the user who wear the smart glasses, the glasses lens appear transparent to them; thin film is hardly noticeable, and the glasses lens appears like regular glasses lens.

As mentioned earlier, the transparent thin film can be coated to increase the reflection/transmission ratio. In this case, it sacrifices the transparency but increases the brightness of the virtual image from the imaging source; in another word, it reduces the brightness requirement of the imaging source.

The transparent thin film may be flat or curved. It can be a concave reflector (parabola or freeform), in which case, it can help to add magnification power for the optic system or help to reduce optical abrasions. The transparent thin film can also be convex reflector, in which case, it will help to expand the eye box.

The transparent thin film can be a small piece as in FIG. 1A, or a longer piece as in FIG. 1B. In the latter case, the left or right end of the thin film can be attached to the frame of the smart glasses.

FIG. 1C depicts an embodiment of AR smart glasses display system, comprising: 1. image formation device (LCD, MicroLED, OLED, LCOS, DLP etc.), denoted as display on the picture. 2. a transparent inside layer and a transparent outside layer; 3. a transparent thin film located between the inside layer and outside layer; 4. and image expansion optics (denoted as “optical lens” in the figures).

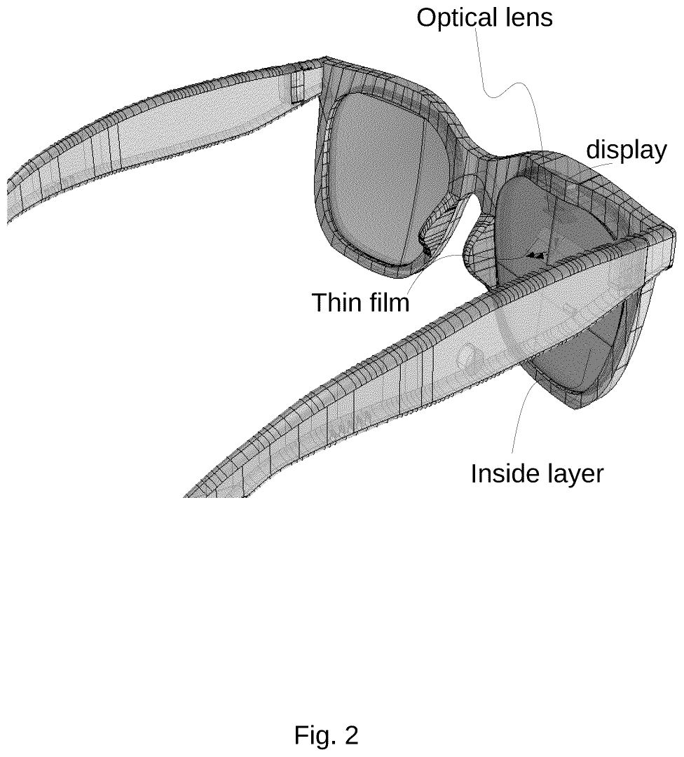

As depicted on FIG. 2, the insider layer is attached onto the frame; the outside layer (although blocked by inside layer and invisible on FIG. 2) is also attached to the frame. The thin film in the middle is attached to the inside layer, and optionally attached to outside layer as well. Display and image expansion optics can be located completely inside the frame; or, some transparent parts can be located between the inside layer and outside layer, but outside of user's natural field of view, as depicted in FIG. 2.

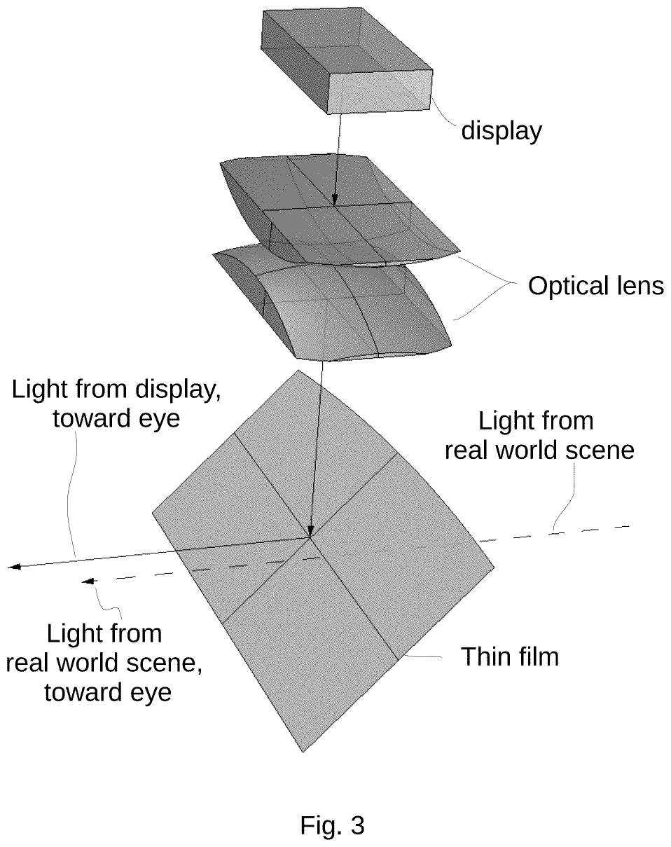

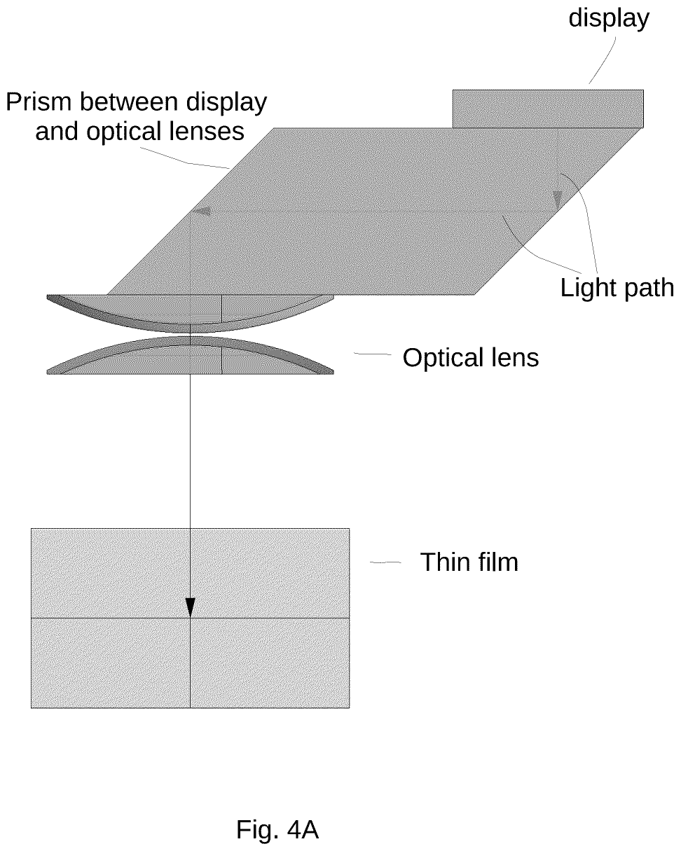

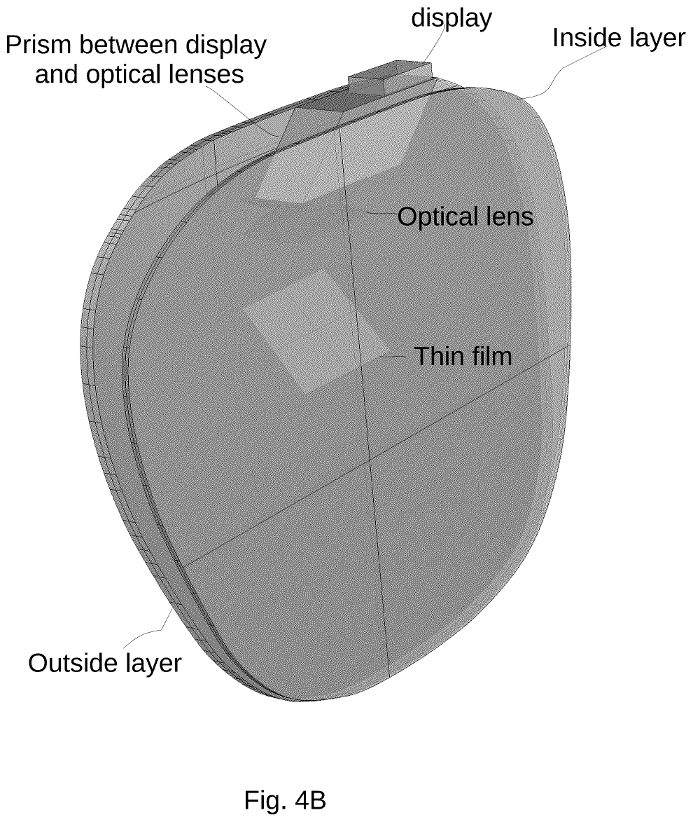

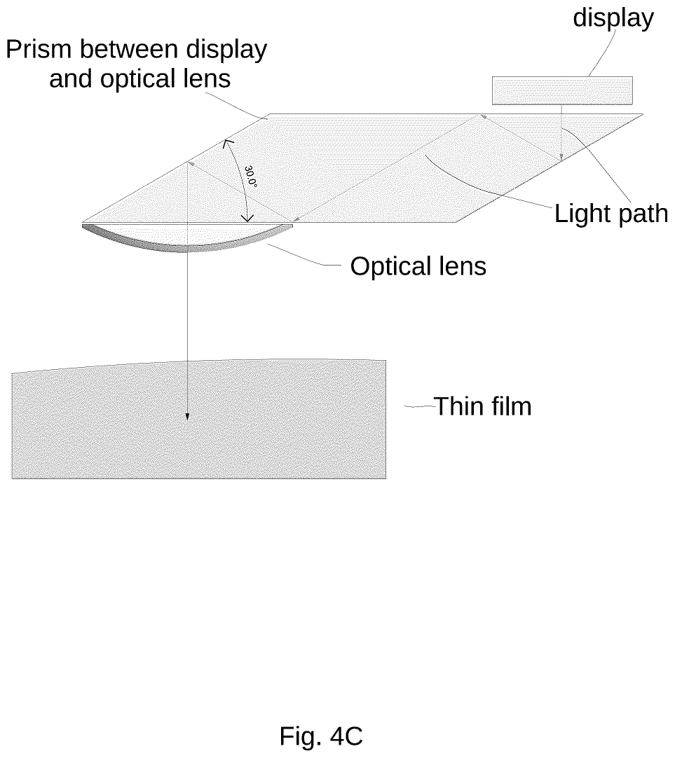

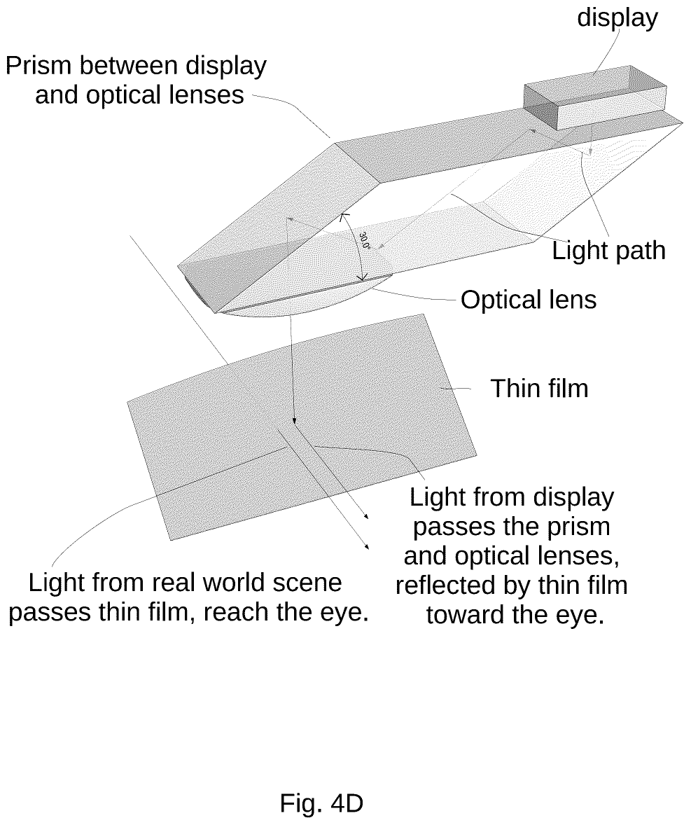

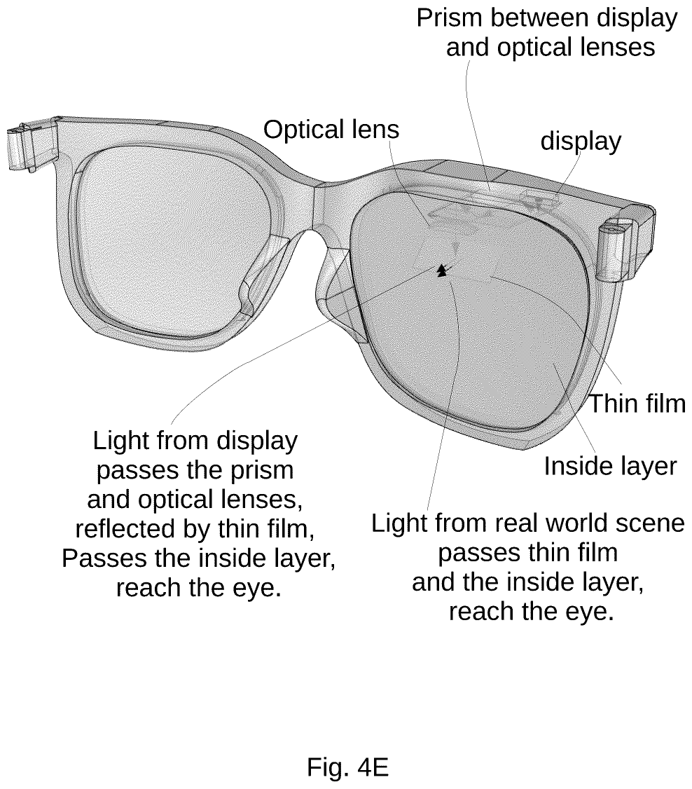

FIG. 3 depicts the light path for one embodiment, purposely omitted the inside layer and outside layer to help revealing inside structure. Lights from display pass through the optical lens, reach the thin film, and reflected by the thin film toward the inside layer, then reach the eye. The light path distance from the display to the optical lens is shorter than the effective focal length of the optical lens, thus, a virtual image of the display is produced on the other side of the optical lens, reflected by the thin film to the eye, perceived as enlarged display. The optical lens can be a single lens or a set of lenses with positive power, can be either spherical or aspherical. One example is a single plano-convex aspherical lens (as in FIG. 4C and FIG. 4D); another example comprises two plano-convex lenses that are placed together, with the two convex surfaces next to each other (as in FIG. 3 and FIG. 4A).

In this embodiment, one advantage is that light from display is invisible from outside of the glasses. Surrounding people won't be able to tell what's showing on the display, or to tell if the display is on or not.

In certain use cases of smart glasses, such as in outdoors, it is desirable to increase the thin film's reflection rate of the display light toward the eye. One way to do this is to use polarization beam splitter plate as the thin film. It still appears transparent, but the reflection rate for polarized light in specific direction can reach more than 90%. This is especially suited for LCD or LCOS displays, light from which are polarized. Another method is to adjust the incident angle of the light coming from the display.

In pictures and texts for describing this embodiment, the display and the optical lens are located above the eye. They can also be located below the eye, or between nose and the eye, or between temple and the eye.

There are multiple ways to mount the thin film inside and without impact the transparent appearance of the structure. It can be either mounted on the optical lenses, or we can extend the thin film toward nose pad and mount it on the frame nearby the nose pad; or extend both ways, one side mounted on the frame nearby nose pad, the other end mounted on the frame nearby the arm hinge.

If the thin film is extended toward the arm hinge side, lights coming from the back side of the user may reach the thin film and reflected to user's eye. To prevent this, we can use linear polarized film as the inside layer of the transparent shell assembly and add a quarter wave plate between the thin film and the inside layer. In this way, when the light from back side passes the inside layer and the quarter wave plate, reflected by the thin film, pass the quarter wave plate again, it will not be able to pass the inside layer (linear polarized film) and cannot reach the eye.

To achieve bigger field of view, longer distance between the display and the optical lenses may be required. There are multiple ways to extend this distance: 1. move the display physically further from the optical lenses, which may need to change the frame shape if we want to hide the display inside the frame; 2. Or, add mirrors in the light path between the display and the optical lenses; light from the display is reflected by the mirrors to the optical lenses. In this way, the light path distance between the display and the optical lenses is extended without the need to physically move the display further from the optical lenses, or the need to manipulate frame shape. 3. Or, we can add one or more prisms between the display and the optical lenses, light from the display is reflected by the internal faces of the prism toward the optical lenses. The reflecting faces may need to be coated with reflection membrane if the incident angle is less than the critical angle for total internal reflection.

In FIG. 4A and FIG. 4B, a prism with a parallelogram base that has a 45-degree angle is added to extend the light path distance between the display and the optical lenses; in this arrangement, the display is moved sideways from the optical lenses, and display can be easily hidden in the frame without changing the shape of the frame.

In FIG. 4C, FIG. 4D, and FIG. 4E, a prism with a parallelogram base that has a 30-degree angle is added to extend the light path distance between the display and the optical lenses. The light is reflected multiple times inside the prism. This design reduced the height of the prism, which makes it possible to move the thin film higher toward the upper frame.

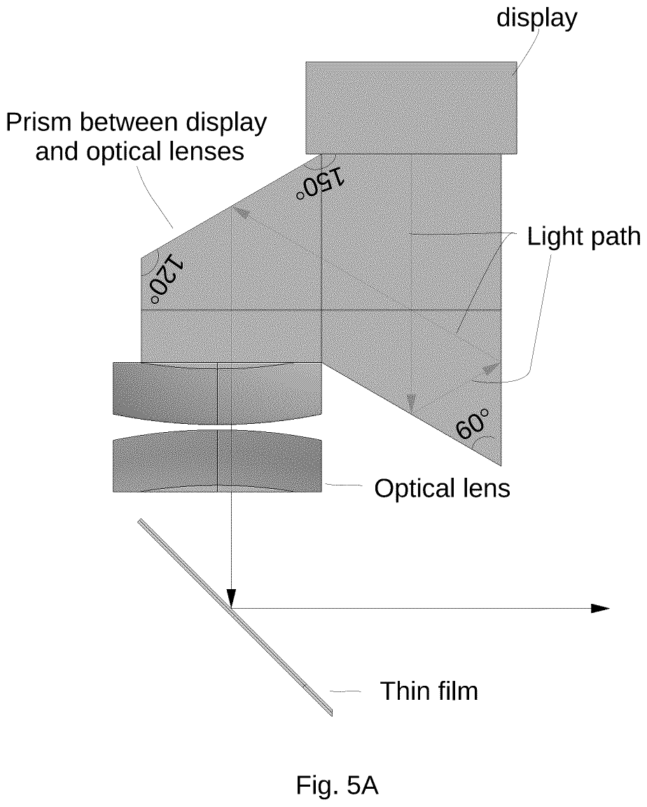

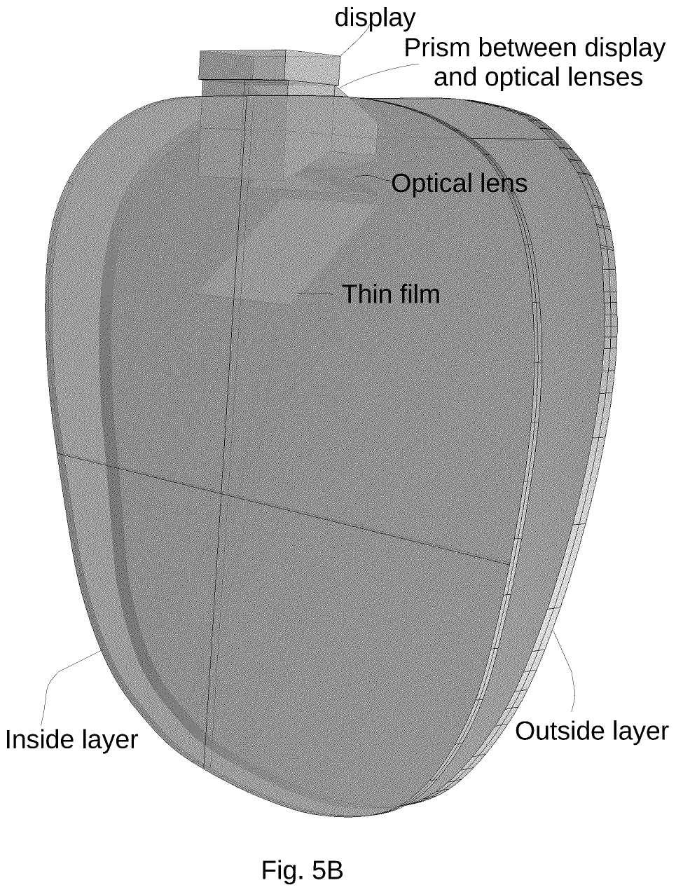

In FIG. 5A and FIG. 5B, a more compact prism is added to extend the light path distance between the display and the optical lenses.

The display, the prism, and the optical lens can be moved together as one unit, horizontally to the nasal side or to the temple side. This enables user to adjust the virtual screen location horizontally, so that the smart glasses can be used by people with different pupillary distance. Similarly, if mirror is used in the place of prism, the display, the mirrors, and the optical lens can be moved together as one unit, enables user to adjust the virtual screen location horizontally.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

1. An optical system for smart glasses to combine digitally generated content with views from environment, comprising a transparent shell assembly and a digital image formation device (denoted as display), wherein said transparent shell assembly comprising:
an inside layer;
an outside layer;
a transparent thin film placed in between said inside layer and said outside layer; said transparent thin film allows light from real world scene to pass through and reach the eye of the wearer of the smart glasses; said transparent thin film is slanted in a way such that light from said display can be reflected by said transparent thin film to the eye of the wearer of the smart glasses.

2. An optical system as in claim 1, wherein the transparent thin film is a polarized beam splitting plate.

3. An optical system as in claim 1, wherein the inside layer and outside layer of the transparent shell assembly are attached to the frame, forming a chamber together with the frame, whereby sands etc. cannot get inside the chamber.

4. An optical system as in claim 1, wherein the outside layer has a spherical shape, whereby the outside layer looks like lenses of regular sunglasses.

5. An optical system as in claim 1, wherein at least one optical lens is placed between the display and the transparent thin film, whereby the light from the display pass through said optical lens, reflected by the thin film, pass through the inside layer of the transparent shell assembly, reach the eye.

6. An optical system as in claim 5, wherein the optical lens(es) has positive power; wherein the light path distance between the display and the optical lens(es) is shorter than the effective focal length of the optical lens(es); whereby a magnified virtual image of the display is formed, and visible to the wearer of the smart glasses through the reflection of the transparent thin film.

7. An optical system as in claim 5, wherein the display and optical lens(es) can be located either above the eye, or between nose and the eye, or below the eye, or between temple and the eye; whereby display and optical lens do not block wearer's view.

8. An optical system as in claim 5, wherein the display and optical lens are embedded inside the frame, invisible from outside; or, the display and optical lens are partially embedded inside the frame; those left outside the frame are transparent, hardly visible to the surrounding people of the wearer of the smart glasses.

9. An optical system as in claim 5, wherein at least one mirror is placed in the light path between the display and the optical lens.

10. An optical system as in claim 5, wherein at least one prism is placed in the light path between the display and the optical lenses, the light from the display enters through one surface of the prism, reflected at least once inside the prism, and leave through a surface of the prism, eventually reaches the optical lenses.

11. An optical system as in claim 10, wherein the prism is a right prism with parallelogram base, wherein the angle of at least one corner of the parallelogram base is 45 degrees.

12. An optical system as in claim 10, wherein the prism is a right prism with parallelogram base, wherein the angle of at least one corner of the parallelogram base is 30 degrees.

13. An optical system as in claim 10, wherein the prism is a right prism, wherein the angle of at least one corner of the base is 60 degrees.

14. An optical system for smart glasses to combine digitally generated content with views from environment, comprising:
a digital image formation device (denoted as display),
a prism,
at least one optical lens,
a transparent thin film;
wherein the light from said display enters through one surface of said prism, reflected at least once inside said prism, and leave through a surface of said prism, reaches and pass through said optical lens(es), and then reflected by said transparent thin film toward the eye of the wearer of the smart glasses;
wherein the optical lens(es) has positive power; the light path distance between the display and the optical lens(es) is shorter than the effective focal length of the optical lens(es); whereby a magnified virtual image of the display is formed, and visible to the wearer of the smart glasses through the reflection of the transparent thin film.

15. An optical system as in claim 14, wherein the prism is a right prism, wherein the angle of a corner of its base is 30 degrees.

16. An optical system as in claim 15, whereas the angle of a corner of its base is 60 degrees.

17. An optical system for smart glasses to combine digitally generated content with views from environment, comprising:
a digital image formation device (denoted as display),
at least one mirror,
at least one optical lens,
a transparent thin film;
wherein the light from said display is reflected by said mirror or mirrors, reaches and passes through said optical lens(es), and then reflected by said transparent thin film toward the eye of the wearer of the smart glasses;
wherein the optical lens(es) has positive power; the light path distance between the display and the optical lens(es) is shorter than the effective focal length of the optical lens(es); whereby a magnified virtual image of the display is formed, and visible to the wearer of the smart glasses through the reflection of the transparent thin film.

18. (canceled)

19. (canceled)

20. An optical system as in claim 10, whereas the display, the prism, and the optical lens can be moved horizontally as one unit to the nasal side or to the temple side; whereby the smart glasses can be used by people with different pupillary distance.

21. An optical system as in claim 14, whereas the display, the prism, and the optical lens can be moved horizontally as one unit to the nasal side or to the temple side; whereby the smart glasses can be used by people with different pupillary distance.

22. An optical system as in claim 9, whereas the display, the mirrors, and the optical lens can be moved horizontally as one unit to the nasal side or to the temple side; whereby the smart glasses can be used by people with different pupillary distance.

23. An optical system as in claim 17, whereas the display, the mirrors, and the optical lens can be moved horizontally as one unit to the nasal side or to the temple side; whereby the smart glasses can be used by people with different pupillary distance.
